(19) United States
(12) Patent Application Publication
(10) Pub. No.: US 2024/0154651 A1
(43) Pub. Date: May 9, 2024

(54) BEAM INDICATIONS FOR SINGLE TRANSMIT RECEIVE POINT AND MULTIPLE TRANSMIT RECEIVE POINT COMMUNICATIONS

(71) Applicant: QUALCOMM Incorporated, San Diego, CA (US)

(72) Inventors: Tianyang BAI, Mountain View, CA (US); Yan ZHOU, San Diego, CA (US); Fang YUAN, Beijing (CN); Tao LUO, San Diego, CA (US); Junyi LI, Fairless Hills, PA (US)

(21) Appl. No.: 18/559,712

(22) PCT Filed: Jul. 5, 2021
(86) PCT No.: PCT/CN2021/104457

§ 371 Date: Nov. 8, 2023

(51) Int. Cl. H04B 7/0417; H04B 7/024

(52) U.S. Cl. CPC H04B 7/0417; H04B 7/024; H04B 7/0628

(57) ABSTRACT

Various aspects of the present disclosure generally relate to wireless communication. In some aspects, a user equipment (UE) may identify, based at least in part on configuration information received from a base station, whether the UE is in a single-transmit receive point (TRP) mode or a multiple-TRP mode. The UE may receive a beam indication that is one of a non-unified beam indication or a unified transmission configuration indicator (TCI) state indication, wherein a type of the beam indication is based at least in part on one or more beam indication rules for the single-TRP mode and the multiple-TRP mode. The UE may communicate with one or more TRPs using one or more beam directions associated with the beam indication. Numerous other aspects are described.

### FIELD OF THE DISCLOSURE

Aspects of the present disclosure generally relate to wireless communication and to techniques and apparatuses for beam indications for single transmit receive point (TRP) and multiple TRP communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to identify, based at least in part on configuration information received from a base station, whether the UE is in a single-transmit receive point (TRP) mode or a multiple-TRP mode. The one or more processors may be configured to receive a beam indication that is one of a non-unified beam indication or a unified transmission configuration indicator (TCI) state indication, wherein a type of the beam indication is based at least in part on one or more beam indication rules for the single-TRP mode and the multiple-TRP mode. The one or more processors may be configured to communicate with one or more TRPs using one or more beam directions associated with the beam indication.

Some aspects described herein relate to a base station for wireless communication. The base station may include a memory and one or more processors coupled to the memory. The one or more processors may be configured to transmit, to a UE, configuration information that identifies whether the UE is in a single-TRP mode or a multiple-TRP mode. The one or more processors may be configured to transmit, to the UE, a beam indication that is one of a non-unified beam indication or a unified TCI state indication, wherein a type of the beam indication is based at least in part on one or more beam indication rules for the single-TRP mode and the multiple-TRP mode. The one or more processors may be configured to communicate with the UE using one or more beam directions associated with the beam indication.

Some aspects described herein relate to a method of wireless communication performed by a UE. The method may include identifying, based at least in part on configuration information received from a base station, whether the UE is in a single-TRP mode or a multiple-TRP mode. The method may include receiving a beam indication that is one of a non-unified beam indication or a unified TCI state indication, wherein a type of the beam indication is based at least in part on one or more beam indication rules for the single-TRP mode and the multiple-TRP mode. The method may include communicating with one or more TRPs using one or more beam directions associated with the beam indication.

Some aspects described herein relate to a method of wireless communication performed by a base station. The method may include transmitting, to a UE, configuration information that identifies whether the UE is in a single-TRP mode or a multiple-TRP mode. The method may include transmitting, to the UE, a beam indication that is one of a non-unified beam indication or a unified TCI state indication, wherein a type of the beam indication is based at least in part on one or more beam indication rules for the single-TRP mode and the multiple-TRP mode. The method may include communicating with the UE using one or more beam directions associated with the beam indication.

Some aspects described herein relate to a non-transitory computer-readable medium that stores a set of instructions for wireless communication by a UE. The set of instructions, when executed by one or more processors of the UE, may cause the UE to identify, based at least in part on configuration information received from a base station, whether the UE is in a single-TRP mode or a multiple-TRP mode. The set of instructions, when executed by one or more processors of the UE, may cause the UE to receive a beam indication that is one of a non-unified beam indication or a unified TCI state indication, wherein a type of the beam indication is based at least in part on one or more beam indication rules for the single-TRP mode and the multiple-TRP mode. The set of instructions, when executed by one or more processors of the UE, may cause the UE to communicate with one or more TRPs using one or more beam directions associated with the beam indication.

Some aspects described herein relate to a non-transitory computer-readable medium that stores a set of instructions for wireless communication by a base station. The set of instructions, when executed by one or more processors of the base station, may cause the base station to transmit, to a UE, configuration information that identifies whether the UE is in a single-TRP mode or a multiple-TRP mode. The set of instructions, when executed by one or more processors of the base station, may cause the base station to transmit, to the UE, a beam indication that is one of a non-unified beam indication or a unified TCI state indication, wherein a type of the beam indication is based at least in part on one or more beam indication rules for the single-TRP mode and the multiple-TRP mode. The set of instructions, when executed by one or more processors of the base station, may cause the base station to communicate with the UE using one or more beam directions associated with the beam indication.

Some aspects described herein relate to an apparatus for wireless communication. The apparatus may include means for identifying, based at least in part on configuration information received from a base station, whether the apparatus is in a single-TRP mode or a multiple-TRP mode. The apparatus may include means for receiving a beam indication that is one of a non-unified beam indication or a unified TCI state indication, wherein a type of the beam indication is based at least in part on one or more beam indication rules for the single-TRP mode and the multiple-TRP mode. The apparatus may include means for communicating with one or more TRPs using one or more beam directions associated with the beam indication.

Some aspects described herein relate to an apparatus for wireless communication. The apparatus may include means for transmitting, to a UE, configuration information that identifies whether the UE is in a single-TRP mode or a multiple-TRP mode. The apparatus may include means for transmitting, to the UE, a beam indication that is one of a non-unified beam indication or a unified TCI state indication, wherein a type of the beam indication is based at least in part on one or more beam indication rules for the single-TRP mode and the multiple-TRP mode. The apparatus may include means for communicating with the UE using one or more beam directions associated with the beam indication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of using beams for communications between a base station and a UE, in accordance with the present disclosure.

FIG. 4 illustrates an example logical architecture of a distributed radio access network (RAN), in accordance with the present disclosure

FIG. 5 is a diagram illustrating an example of multi-transmit receive point (TRP) communication, in accordance with the present disclosure.

FIG. 6 is a diagram illustrating an example of TRP differentiation at a UE based at least in part on a control resource set (CORESET) pool index, in accordance with the present disclosure.

FIG. 7 is a diagram illustrating an example associated with beam indications for single TRP and multiple TRP communications, in accordance with the present disclosure.

FIGS. 8-9 are diagrams illustrating example processes associated with beam indications for single TRP and multiple TRP communications, in accordance with the present disclosure.

FIGS. 10-11 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

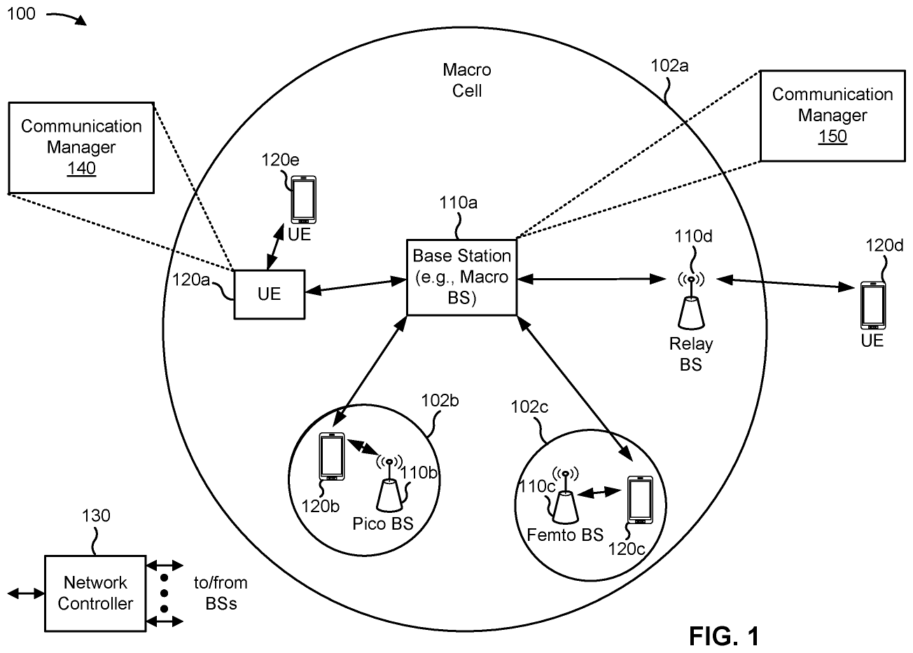

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may identify, based at least in part on configuration information received from a base station, whether the UE is in a single-TRP mode or a multiple-TRP mode; receive a beam indication that is one of a non-unified beam indication or a unified transmission configuration indicator (TCI) state indication, wherein a type of the beam indication is based at least in part on one or more beam indication rules for the single-TRP mode and the multiple-TRP mode; and communicate with one or more TRPs using one or more beam directions associated with the beam indication. Additionally, or alternatively, the communication manager 140 may perform one or more other operations described herein.

In some aspects, the base station 110 may include a communication manager 150. As described in more detail elsewhere herein, the communication manager 150 may transmit, to a UE, configuration information that identifies whether the UE is in a single-TRP mode or a multiple-TRP mode; transmit, to the UE, a beam indication that is one of a non-unified beam indication or a unified TCI state indication, wherein a type of the beam indication is based at least in part on one or more beam indication rules for the single-TRP mode and the multiple-TRP mode; and communicate with the UE using one or more beam directions associated with the beam indication. Additionally, or alternatively, the communication manager 150 may perform one or more other operations described herein.

As indicated above, FIG. 1 is provided as an example. Other examples may differ from what is described with regard to FIG. 1.

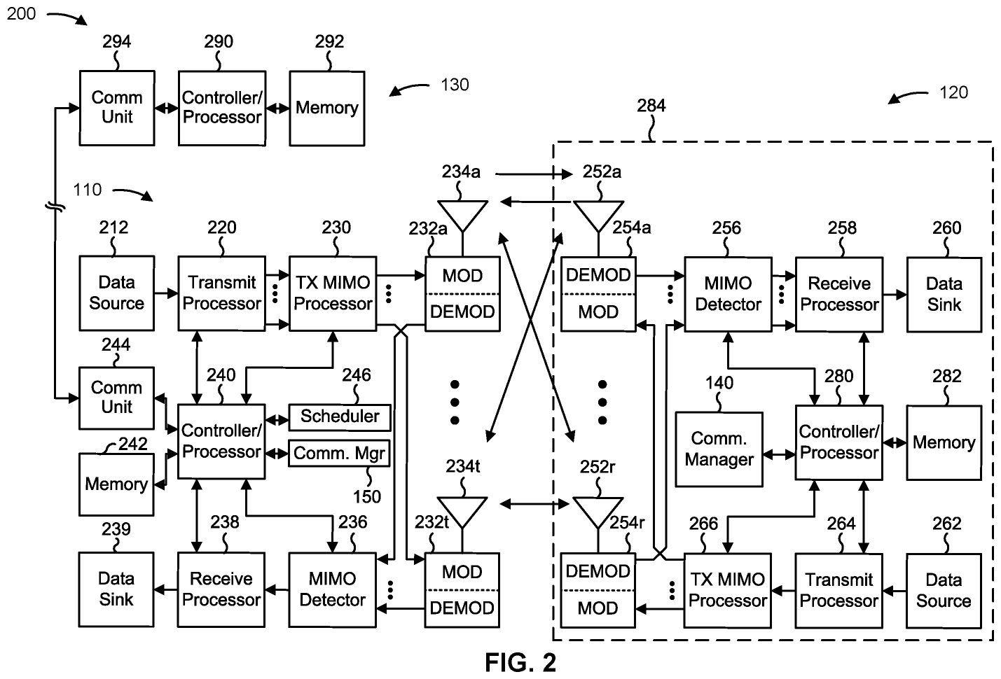

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

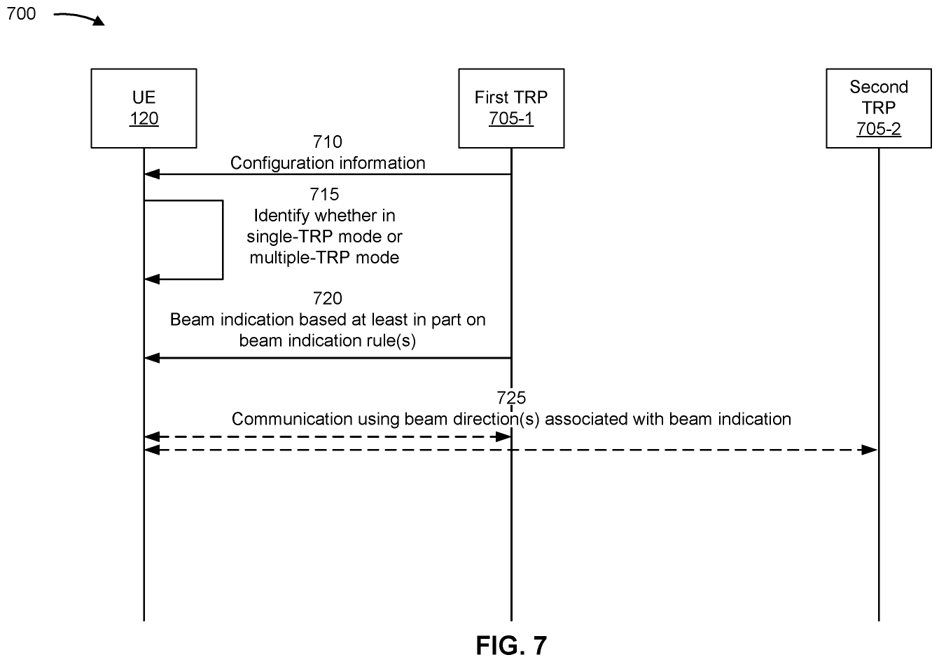

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-11).

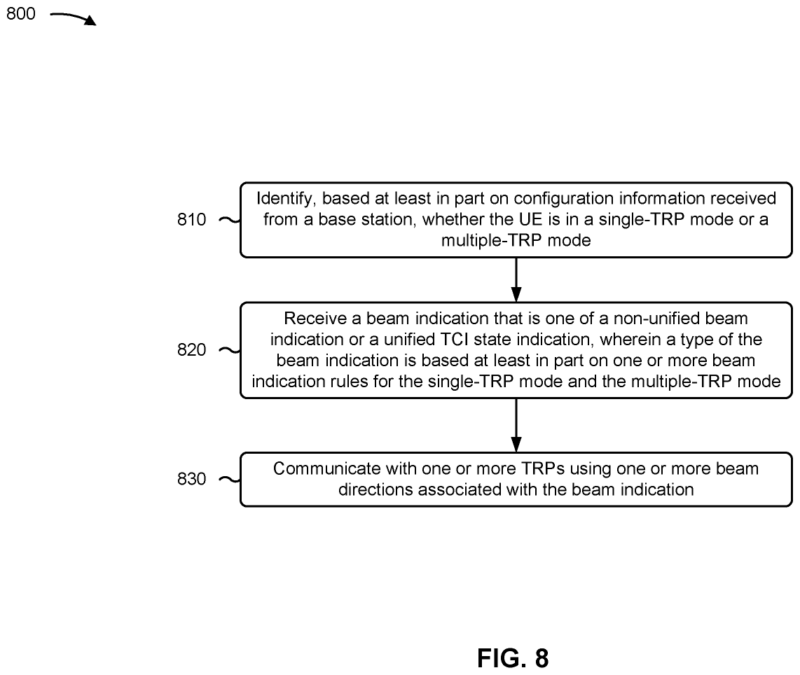

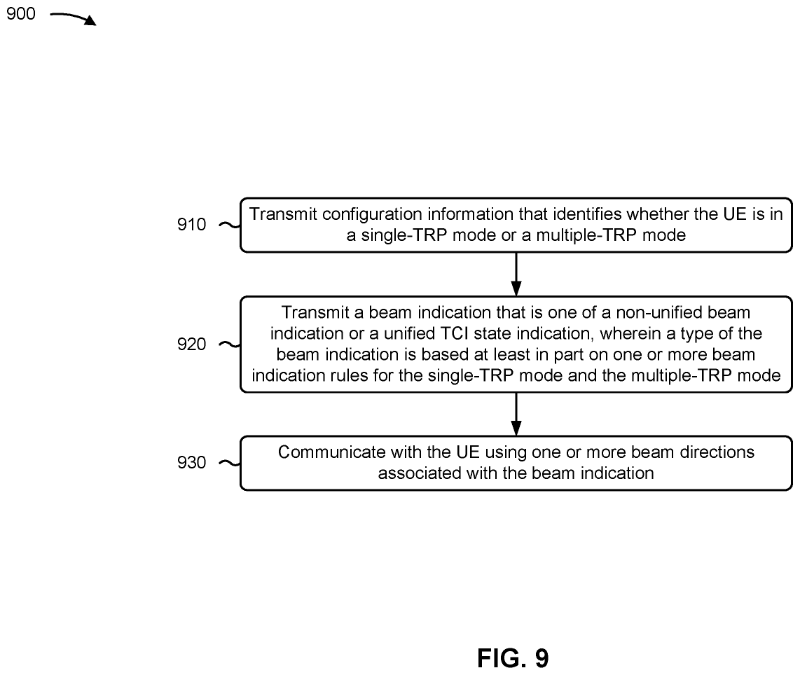

The controller/processor 240 of the base station 110, the controller/processor 280 of the UE 120, and/or any other component(s) of FIG. 2 may perform one or more techniques associated with beam indications for single TRP and multiple TRP communication, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples. In some aspects, the TRP described herein is the base station 110, is included in the base station 110, or includes one or more components of the base station 110 shown in FIG. 2.

In some aspects, the UE 120 includes means for identifying, based at least in part on configuration information received from a base station, whether the UE is in a single-TRP mode or a multiple-TRP mode; means for receiving a beam indication that is one of a non-unified beam indication or a unified TCI state indication, wherein a type of the beam indication is based at least in part on one or more beam indication rules for the single-TRP mode and the multiple-TRP mode; and/or means for communicating with one or more TRPs using one or more beam directions associated with the beam indication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station 110 includes means for transmitting, to a UE, configuration information that identifies whether the UE is in a single-TRP mode or a multiple-TRP mode; means for transmitting, to the UE, a beam indication that is one of a non-unified beam indication or a unified TCI state indication, wherein a type of the beam indication is based at least in part on one or more beam indication rules for the single-TRP mode and the multiple-TRP mode; and/or means for communicating with the UE using one or more beam directions associated with the beam indication. The means for the base station 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

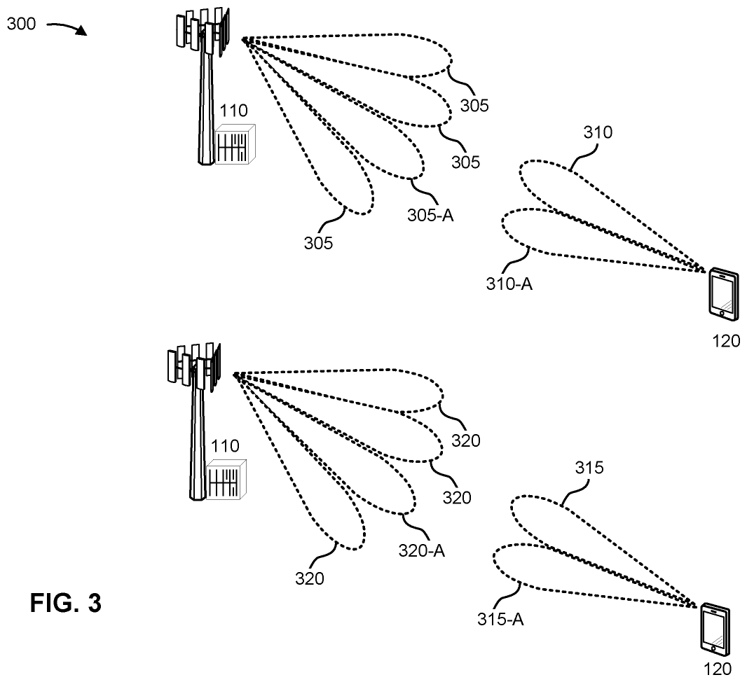

FIG. 3 is a diagram illustrating an example 300 of using beams for communications between a base station and a UE, in accordance with the present disclosure. As shown in FIG. 3, a base station 110 and a UE 120 may communicate with one another.

The base station 110 may transmit to UEs 120 located within a coverage area of the base station 110. The base station 110 and the UE 120 may be configured for beamformed communications, where the base station 110 may transmit in the direction of the UE 120 using a directional BS transmit beam, and the UE 120 may receive the transmission using a directional UE receive beam. Each BS transmit beam may have an associated beam ID, beam direction, or beam symbols, among other examples. The base station 110 may transmit downlink communications via one or more BS transmit beams 305.

The UE 120 may attempt to receive downlink transmissions via one or more UE receive beams 310, which may be configured using different beamforming parameters at receive circuitry of the UE 120. The UE 120 may identify a particular BS transmit beam 305, shown as BS transmit beam 305-A, and a particular UE receive beam 310, shown as UE receive beam 310-A, that provide relatively favorable performance (for example, that have a best channel quality of the different measured combinations of BS transmit beams 305 and UE receive beams 310). In some examples, the UE 120 may transmit an indication of which BS transmit beam 305 is identified by the UE 120 as a preferred BS transmit beam, which the base station 110 may select for transmissions to the UE 120. The UE 120 may thus attain and maintain a beam pair link (BPL) with the base station 110 for downlink communications (for example, a combination of the BS transmit beam 305-A and the UE receive beam 310-A), which may be further refined and maintained in accordance with one or more established beam refinement procedures.

A downlink beam, such as a BS transmit beam 305 or a UE receive beam 310, may be associated with a TCI state. A TCI state may indicate a directionality or a characteristic of the downlink beam, such as one or more quasi co-location (QCL) properties of the downlink beam. A QCL property may include, for example, a Doppler shift, a Doppler spread, an average delay, a delay spread, or spatial receive parameters, among other examples. In some examples, each BS transmit beam 305 may be associated with a synchronization signal block (SSB), and the UE 120 may indicate a preferred BS transmit beam 305 by transmitting uplink transmissions in resources of the SSB that are associated with the preferred BS transmit beam 305. A particular SSB may have an associated TCI state (for example, for an antenna port or for beamforming). The base station 110 may, in some examples, indicate a downlink BS transmit beam 305 based at least in part on antenna port QCL properties that may be indicated by the TCI state. A TCI state may be associated with one downlink reference signal set (for example, an SSB and an aperiodic, periodic, or semi-persistent channel state information reference signal (CSI-RS)) for different QCL types (for example, QCL types for different combinations of Doppler shift, Doppler spread, average delay, delay spread, or spatial receive parameters, among other examples). In cases where the QCL type indicates spatial receive parameters, the QCL type may correspond to analog receive beamforming parameters of a UE receive beam 310 at the UE 120. Thus, the UE 120 may select a corresponding UE receive beam 310 from a set of BPLs based at least in part on the base station 110 indicating a BS transmit beam 305 via a TCI indication.

The base station 110 may maintain a set of activated TCI states for downlink shared channel transmissions and a set of activated TCI states for downlink control channel transmissions. The set of activated TCI states for downlink shared channel transmissions may correspond to beams that the base station 110 uses for downlink transmission on a physical downlink shared channel (PDSCH). The set of activated TCI states for downlink control channel communications may correspond to beams that the base station 110 may use for downlink transmission on a physical downlink control channel (PDCCH) or in a control resource set (CORESET). The UE 120 may also maintain a set of activated TCI states for receiving the downlink shared channel transmissions and the CORESET transmissions. If a TCI state is activated for the UE 120, then the UE 120 may have one or more antenna configurations based at least in part on the TCI state, and the UE 120 may not need to reconfigure antennas or antenna weighting configurations. In some examples, the set of activated TCI states (for example, activated PDSCH TCI states and activated CORESET TCI states) for the UE 120 may be configured by a configuration message, such as a radio resource control (RRC) message.

Similarly, for uplink communications, the UE 120 may transmit in the direction of the base station 110 using a directional UE transmit beam, and the base station 110 may receive the transmission using a directional BS receive beam. Each UE transmit beam may have an associated beam ID, beam direction, or beam symbols, among other examples. The UE 120 may transmit uplink communications via one or more UE transmit beams 315.

The base station 110 may receive uplink transmissions via one or more BS receive beams 320. The base station 110 may identify a particular UE transmit beam 315, shown as UE transmit beam 315-A, and a particular BS receive beam 320, shown as BS receive beam 320-A, that provide relatively favorable performance (for example, that have a best channel quality of the different measured combinations of UE transmit beams 315 and BS receive beams 320). In some examples, the base station 110 may transmit an indication of which UE transmit beam 315 is identified by the base station 110 as a preferred UE transmit beam, which the base station 110 may select for transmissions from the UE 120. The UE 120 and the base station 110 may thus attain and maintain a BPL for uplink communications (for example, a combination of the UE transmit beam 315-A and the BS receive beam 320-A), which may be further refined and maintained in accordance with one or more established beam refinement procedures. In some examples, an uplink beam, such as a UE transmit beam 315 or a BS receive beam 320, may be associated with a spatial relation. A spatial relation may indicate a directionality or a characteristic of the uplink beam, similar to one or more QCL properties, as described above.

As described above in some examples, a TCI state may be used for a downlink beam indication and a spatial relation may be used for an uplink beam indication. Such beam indications may be referred to herein as “non-unified beam indications.” Non-unified beam indications may be applied to one channel for one communication scheduled in that channel.

In some examples, the base station 110 and the UE 120 may use a unified TCI state framework for both downlink and uplink beam indications. In the unified TCI state framework, TCI state indications may be used to indicate a joint downlink and uplink TCI state or to indicate separate downlink and uplink TCI states. Such a TCI state indication that may be used to indicate a joint downlink and uplink beam, a separate downlink beam, or a separate uplink beam is referred to herein as a “unified TCI state indication.” A unified TCI state indication (e.g., a joint downlink and uplink TCI state indication and/or separate downlink and uplink TCI state indications) may be applied to multiple channels. For example, the unified TCI state indication of a joint uplink and downlink TCI state may be used to indicate a beam direction for one or more downlink channels (e.g., PDSCH and/or PDCCH) and for one or more uplink channels (e.g., a physical uplink shared channel (PUSCH) and/or a physical uplink control channel (PUCCH)). The unified TCI state indication of a separate downlink TCI state may be used to indicate a beam direction for multiple downlink channels (e.g., PDSCH and PDCCH). The unified TCI state indication of a separate uplink TCI state may be used to indicate a beam direction to be used for multiple uplink channels (e.g., PUSCH and PUCCH). In some examples, the unified TCI state indication may be “sticky,” such that the indicated beam direction will be used for the channels to which the TCI state indication applies until a further indication is received.

In some examples, there may be two TCI state indication modes in the unified TCI state framework. A first mode may be a separate downlink and uplink TCI state indication mode, in which separate downlink and uplink TCI states are used to indicate downlink and uplink beam directions for the UE 120. For example, the separate downlink and uplink TCI state indication mode may be used when the UE 120 is having maximum permissible exposure (MPE) issues to indicate different beam directions, for the UE 120, for an uplink beam (e.g., a UE transmit beam 315) and a downlink beam (e.g., a UE receive beam 310). A second mode may be a joint downlink and uplink TCI state indication mode, in which a TCI state indication is used to indicate, to the UE 120, a joint uplink and downlink beam direction. For example, the joint downlink and uplink TCI state indication mode may be used when the UE 120 has channel correspondence between downlink and uplink channels (which may be assumed in some examples), and the same beam direction can be used for an uplink beam (e.g., a UE transmit beam 315) and a downlink beam (e.g., a UE receive beam 315).

As indicated above, FIG. 3 is provided as an example. Other examples may differ from what is described with respect to FIG. 3.

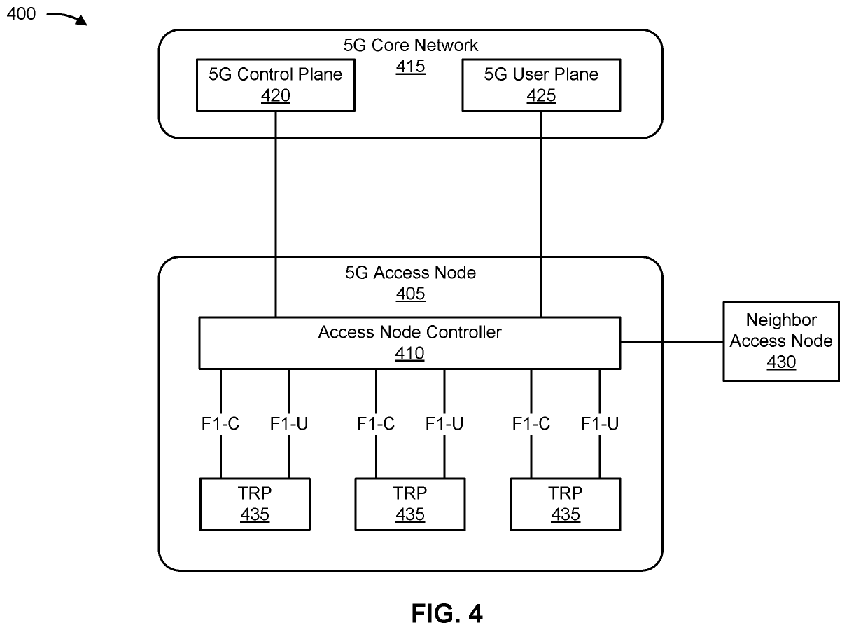

FIG. 4 illustrates an example logical architecture of a distributed radio access network (RAN) 400, in accordance with the present disclosure.

A 5G access node 405 may include an access node controller 410. The access node controller 410 may be a central unit (CU) of the distributed RAN 400. In some aspects, a backhaul interface to a 5G core network 415 may terminate at the access node controller 410. The 5G core network 415 may include a 5G control plane component 420 and a 5G user plane component 425 (e.g., a 5G gateway), and the backhaul interface for one or both of the 5G control plane and the 5G user plane may terminate at the access node controller 410. Additionally, or alternatively, a backhaul interface to one or more neighbor access nodes 430 (e.g., another 5G access node 405 and/or an LTE access node) may terminate at the access node controller 410.

The access node controller 410 may include and/or may communicate with one or more TRPs 435 (e.g., via an F1 Control (F1-C) interface and/or an F1 User (F1-U) interface). A TRP 435 may be a distributed unit (DU) of the distributed RAN 400. In some aspects, a TRP 435 may correspond to a base station 110 described above in connection with FIG. 1. For example, different TRPs 435 may be included in different base stations 110. Additionally, or alternatively, multiple TRPs 435 may be included in a single base station 110. In some aspects, a base station 110 may include a CU (e.g., access node controller 410) and/or one or more DUs (e.g., one or more TRPs 435). In some cases, a TRP 435 may be referred to as a cell, a panel, an antenna array, or an array.

A TRP 435 may be connected to a single access node controller 410 or to multiple access node controllers 410. In some aspects, a dynamic configuration of split logical functions may be present within the architecture of distributed RAN 400. For example, a packet data convergence protocol (PDCP) layer, a radio link control (RLC) layer, and/or a medium access control (MAC) layer may be configured to terminate at the access node controller 410 or at a TRP 435.

In some aspects, multiple TRPs 435 may transmit communications (e.g., the same communication or different communications) in the same transmission time interval (TTI) (e.g., a slot, a mini-slot, a subframe, or a symbol) or different TTIs using different QCL relationships (e.g., different spatial parameters, different TCI states, different precoding parameters, and/or different beamforming parameters). In some aspects, a TCI state may be used to indicate one or more QCL relationships. A TRP 435 may be configured to individually (e.g., using dynamic selection) or jointly (e.g., using joint transmission with one or more other TRPs 435) serve traffic to a UE 120.

As indicated above, FIG. 4 is provided as an example. Other examples may differ from what was described with regard to FIG. 4.

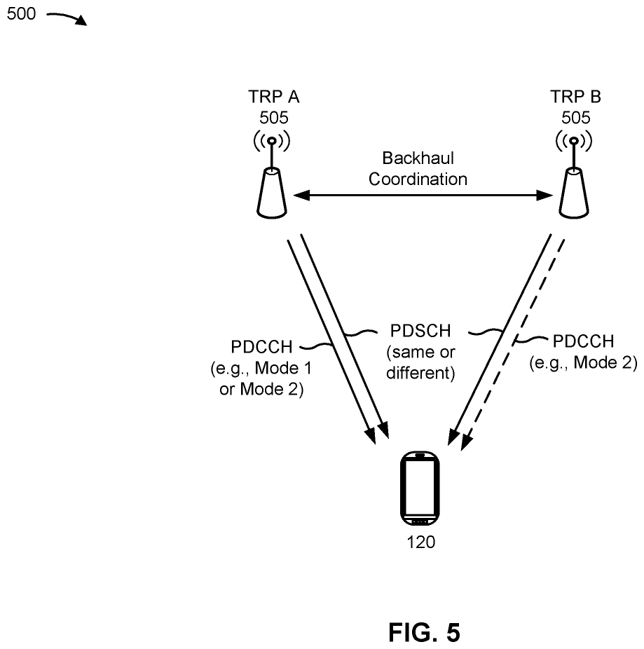

FIG. 5 is a diagram illustrating an example 500 of multi-TRP communication (sometimes referred to as multi-panel communication), in accordance with the present disclosure. As shown in FIG. 5, multiple TRPs 505 may communicate with the same UE 120. A TRP 505 may correspond to a TRP 435 described above in connection with FIG. 4.

The multiple TRPs 505 (shown as TRP A and TRP B) may communicate with the same UE 120 in a coordinated manner (e.g., using coordinated multipoint transmissions) to improve reliability and/or increase throughput. The TRPs 505 may coordinate such communications via an interface between the TRPs 505 (e.g., a backhaul interface and/or an access node controller 410). The interface may have a smaller delay and/or higher capacity when the TRPs 505 are co-located at the same base station 110 (e.g., when the TRPs 505 are different antenna arrays or panels of the same base station 110), and may have a larger delay and/or lower capacity (as compared to co-location) when the TRPs 505 are located at different base stations 110. The different TRPs 505 may communicate with the UE 120 using different QCL relationships (e.g., different TCI states), different DMRS ports, and/or different layers (e.g., of a multi-layer communication).

In a first multi-TRP transmission mode (e.g., Mode 1), a single PDCCH may be used to schedule downlink data communications for a single PDSCH. In this case, multiple TRPs 505 (e.g., TRP A and TRP B) may transmit communications to the UE 120 on the same PDSCH. For example, a communication may be transmitted using a single codeword with different spatial layers for different TRPs 505 (e.g., where one codeword maps to a first set of layers transmitted by a first TRP 505 and maps to a second set of layers transmitted by a second TRP 505). As another example, a communication may be transmitted using multiple codewords, where different codewords are transmitted by different TRPs 505 (e.g., using different sets of layers). In either case, different TRPs 505 may use different QCL relationships (e.g., different TCI states) for different DMRS ports corresponding to different layers. For example, a first TRP 505 may use a first QCL relationship or a first TCI state for a first set of DMRS ports corresponding to a first set of layers, and a second TRP 505 may use a second (different) QCL relationship or a second (different) TCI state for a second (different) set of DMRS ports corresponding to a second (different) set of layers. In some examples, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1). In some examples, a single TCI codepoint (e.g., in the TCI field in the DCI) may be associated with two TCI states (e.g., the first TCI state associated with the first TRP 505 and the second TCI state associated with the second TRP 505). In this case, a single indication in the TCI field may be used to indicate two TCI states for multiple-TRP transmission of the PDSCH. The first multi-TRP transmission mode (e.g., Mode 1) may be referred to as a single DCI multiple-TRP mode.

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 505, and a second PDCCH may schedule a second codeword to be transmitted by a second TRP 505. Furthermore, first DCI (e.g., transmitted by the first TRP 505) may schedule a first PDSCH communication associated with a first set of DMRS ports with a first QCL relationship (e.g., indicated by a first TCI state) for the first TRP 505, and second DCI (e.g., transmitted by the second TRP 505) may schedule a second PDSCH communication associated with a second set of DMRS ports with a second QCL relationship (e.g., indicated by a second TCI state) for the second TRP 505. In this case, DCI (e.g., having DCI format 1_0 or DCI format 1_1) may indicate a corresponding TCI state for a TRP 505 corresponding to the DCI. The TCI field of a DCI indicates the corresponding TCI state (e.g., the TCI field of the first DCI indicates the first TCI state and the TCI field of the second DCI indicates the second TCI state). The second multi-TRP transmission mode (e.g., Mode 2) may be referred to as a multiple DCI multiple-TRP mode.

As indicated above, FIG. 5 is provided as an example. Other examples may differ from what is described with respect to FIG. 5.

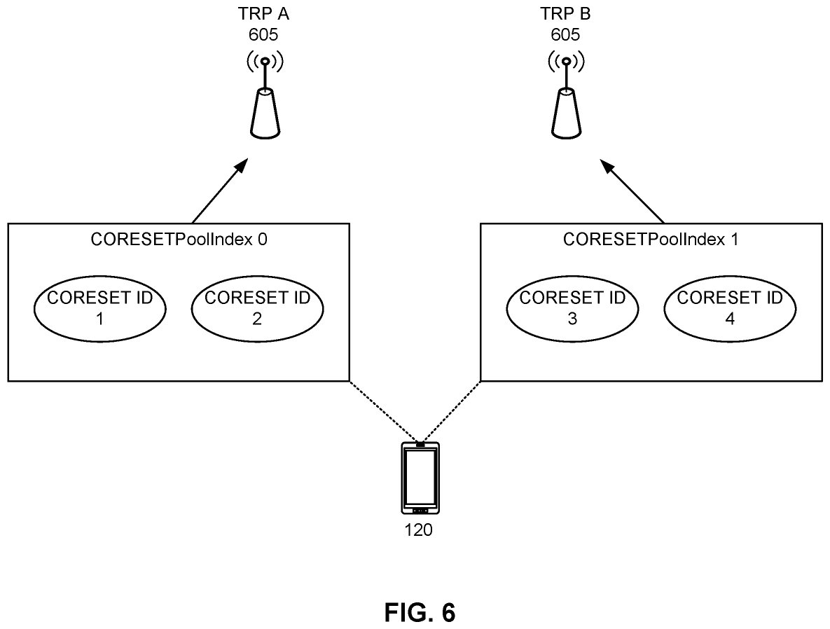

FIG. 6 is a diagram illustrating an example of TRP differentiation at a UE based at least in part on a CORESET pool index, in accordance with the present disclosure. In some examples, a CORESET pool index (or CORESETPoolIndex) value may be used by a UE (e.g., UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an OFDM slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using RRC signaling to indicate a frequency domain region (for example, a quantity of resource blocks) or a time domain region (for example, a quantity of symbols) for the CORESET.

As shown in FIG. 6, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further shown in FIG. 6, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 605. For example, and as shown in FIG. 6, a first TRP 605 (TRP A) may be associated with CORESET pool index 0 and a second TRP 605 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE 120 may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 6 is provided as an example. Other examples may differ from what is described with respect to FIG. 6.

As described above in connection with FIG. 3, a unified TCI state indication may be used to indicate a joint downlink and uplink beam, a separate downlink beam, and/or a separate uplink beam. However, using unified TCI state indications to provide beam indications for multiple-TRP communications is not straightforward and may result in confusion for a UE as to which beams to use. For example, a unified TCI state indication for a downlink beam (e.g., a joint downlink and uplink TCI state indication or a separate downlink TCI state indication) may be used for PDSCH and for PDCCH in a single-TRP case. However, in a single DCI multiple-TRP case, a unified TCI state indication may indicate downlink beams (e.g., a first TCI state and a second TCI state) for the PDSCH transmissions from two TRPs, but the UE may not know which downlink beam to use for the single PDCCH transmission. Furthermore, in a multiple-TRP case, a UE may not know how to determine PDSCH and PUCCH beams for a joint uplink and downlink TCI state indication. In addition, the UE may not know from a unified TCI state indication which beam(s) to use for PDCCH and/or PUCCH repetitions. As a result, reliability may be decreased, and latency may be increased, for multiple-TRP communications for a UE.

Some techniques and apparatuses described herein enable a UE to identify, based at least in part on configuration information received from a base station, whether the UE is in a single-TRP mode or a multiple-TRP mode. The UE may receive a beam indication that is one of a non-unified beam indication or a unified TCI state indication, and the type of the beam indication may be based at least in part on one or more beam indication rules for the single-TRP mode and the multiple-TRP mode. The UE may then communicate with one or more TRPs using one or more beam directions associated with the beam indication. In some aspects, the beam indication rules may determine whether a unified TCI state indication may be used in the multiple-TRP mode, and if so, how the UE may determine which beams to use (e.g., in cases of single DCI multiple-TRP, joint downlink and uplink beam indication, and/or PDCCH or PUCCH repetitions). As a result, reliability may be increased, and latency decreased, for multiple-TRP communications for the UE.

FIG. 7 is a diagram illustrating an example 700 associated with beam indications for single TRP and multiple TRP communications, in accordance with the present disclosure. As shown in FIG. 7, example 700 includes communication between a UE 120, a first TRP 705-1, and a second TRP 705-2. In some aspects, the first TRP 705-1, the second TRP 705-2, and UE 120 may be included in a wireless network, such as wireless network 100. The UE 120 may communicate with the first TRP 705-1 and the second TRP 705-2 via wireless access links, which may include uplinks and downlinks.

The first TRP 705-1 and the second TRP 705-2 (collectively, TRPs 705) may correspond to TRPs described elsewhere herein, such as TRPs 435 described above in connection with FIG. 4, TRPs 505 described above in connection with FIG. 5, and/or TRPs 605 described above in connection with FIG. 6. The TRPs 705 may communicate with each other and may coordinate communications with the UE 120 via an interface between the TRPs 705 (e.g., a backhaul interface and/or an access node controller). In some aspects, the TRPs 705 may be in the same cell. For example, the TRPs 705 may be DUs associated with the same 5G access node (e.g., gNB). In some aspects, the TRPs 705 may be co-located at the same base station 110. For example, the TRPs 705 may be different antenna arrays or panels of the same base station 110. In some aspects, the TRPs 705 may be located at different base stations 110.

As shown in FIG. 7, and by reference number 710, the UE 120 may receive configuration information transmitted from a base station 110 (e.g., transmitted from the first TRP 705-1). In some aspects, the configuration information may include information that identifies (or may be used to identify) whether the UE 120 is in a multiple-TRP mode (e.g., the UE 120 is being served by multiple TRPs 705) or in a single-TRP mode (e.g., the UE 120 is being served by a single TRP 705). For example, the configuration information may include CORESET configuration for the UE 120, and the CORSET configuration may configure a CORESET pool ID (e.g., CORESETPoolID) for the UE 120 in the multiple-TRP mode. The CORESET pool ID is a field that indicates a mapping between a TCI codepoint that may be indicated in DCI and multiple TCI states (e.g., a first TCI state and a second TCI state) associated with multiple TRPs. For example, each of the multiple TCI states that are associated with a TCI indication (e.g., a TCI codepoint) may be have a respective CORESET pool ID index value. In some aspects, the base station 110 (e.g., the first TRP 705-1) may transmit the configuration information to the UE 120 in an RRC message.

As further shown in FIG. 7, and by reference number 715, the UE 120 may identify whether the UE 120 is in the single-TRP mode of the multiple-TRP mode based at least in part on the configuration information. In some aspects, the UE 120 may determine whether the CORESET pool ID is configured in the CORESET configuration. In this case, the UE 120 may determine that the UE 120 is in the single-TRP mode (e.g., the UE 120 is being served by a single TRP 705) based at least in part on a determination that the CORESET pool ID is not configured for the UE 120. The UE 120 may determine that UE 120 is in the multiple-TRP mode (e.g., the UE 120 is being served by multiple TRPs 705) based at least in part on a determination that the CORESET pool ID is configured for the UE 120.

As further shown in FIG. 7, and by reference number 720, the UE 120 may receive, from a TRP (e.g., the first TRP 705-1) or base station 110, a beam indication. In some aspects, the type of beam indication (e.g., a non-unified beam indication or a unified beam indication) received by the UE 120 may be based at least in part on one or more beam indication rules for the single-TRP mode and the multiple-TRP mode. For example, the beam indication rule(s) may control which type or types of beam indications may be used for the single-TRP mode and the multiple-TRP mode.

In some aspects, all or a subset of the one or more beam indication rules for the single TRP-mode and the multiple-TRP mode may be preset, such as in a wireless communication standard. In some aspects, all of a subset of the one or more beam indication rules for the single TRP-mode and the multiple-TRP mode may be configured for the UE 120 by signaling from the base station 110. For example, all of a subset of the one or more beam indication rules for the single TRP-mode and the multiple-TRP mode may be included in the configuration information or other configuration information transmitted by the base station 110 (e.g., via a TRP 705) to the UE 120.

In some aspects, according to the beam indication rule(s) for the single-TRP mode and the multiple-TRP mode, a non-unified beam indication may be used in the multiple-TRP mode, and either a unified TCI state indication or a non-unified beam indication may be used in the single-TRP mode. In this case, when the UE 120 is in the multiple-TRP mode, the UE 120 may receive the non-unified beam indication, such as a non-unified TCI state indication that indicates first and second downlink beam directions for a receiving a PDSCH communication from the first TRP 705 and the second TRP 705-2 or a spatial relation indication that indicates an uplink beam direction for an uplink communication to one of the TRPs 705. In some aspects, when the UE 120 is in the single-TRP mode, the beam indication type (e.g., unified TCI state indication or non-unified beam indication) may be based at least in part on a network configuration. For example, the UE 120 may receive, from the base station 110, a beam indication configuration that indicates which type of beam indication will be received by the UE 120 when the UE 120 is in the single-TRP mode. In some aspects, when the UE 120 is in the single-TRP mode, the beam indication type (e.g., unified TCI state indication or non-unified beam indication) may be based at least in part on a UE capability. For example, the UE 120 may transmit, to the base station 110, a UE capability report that includes an indication of a UE capability for supporting unified TCI state indications, and the base station 110 may determine whether to use a unified TCI state indication or the non-unified beam indication for the UE 120 in the single-TRP mode based at least in part on the indicated UE capability.

In some aspects, the type of beam indication to be used for the UE 120 in the multiple-TRP mode may be based at least in part on a UE capability. For example, the UE 120 may transmit, to the base station 110, a UE capability report that indicates a UE capability for supporting unified TCI state indications in the multiple-TRP mode, and the base station 110 may determine whether to use a unified TCI state indication or the non-unified beam indication for the UE 120 in the multiple-TRP mode based at least in part on the indicated UE capability. In some aspects, the UE capability report may indicate the UE capability for supporting unified TCI state indications in the single DCI multiple-TRP mode and/or the UE capability for supporting unified TCI state indications in the multiple DCI multiple-TRP mode.

In some aspects, the one or more beam indication rules may permit unified TCI state indications to be used for the UE 120 in the multiple-TRP mode, and the UE 120 may receive a unified TCI indication in the multiple-TRP mode. For example, the unified TCI indication received by the UE 120 may be a joint downlink and uplink TCI state indication, a separate downlink TCI state indication, or a separate uplink TCI state indication. In some aspects, in a case in which the UE 120 is permitted to receive unified TCI state indications in the multiple-TRP mode, the one or more beam indication rules may include rules that control how the unified TCI state indications are applied by the UE 120 in the multiple-TRP mode (e.g., for the single DCI multiple-TRP mode and/or for the multiple DCI multiple-TRP mode).

In some aspects, the beam indication (e.g., the unified TCI state indication or the non-unified beam indication) may be transmitted by the base station 110 or a TRP 705 (e.g., the first TRP 705-1) in a MAC control element (MAC-CE) or in DCI. In some aspects, when the UE 120 is in the multiple-TRP mode, a beam indication for a downlink beam, whether a unified TCI state indication (e.g., the separate downlink TCI state indication or the joint downlink and uplink TCI state indication) or a non-unified beam indication (e.g., the non-unified TCI state indication), may be a TCI codepoint that is associated with a first TCI state (e.g., for the first TRP 705-1) and a second TCI state (e.g., for second TRP 705-2).

As further shown in FIG. 7, and by reference number 725, the UE 120 may communicate with the first TRP 705-1 and/or the second TRP 705-2 using one or more beam directions associated with the beam indication. The base station 110 (e.g., via the first TRP 705-1 and/or the second TRP 705-2) may communicate with the UE 120 using the one or more beam directions associated with the beam indication.

In a case in which the UE 120 is in the single-TRP mode, the UE 120 may communicate with a single TRP 705 (e.g., the first TRP 705-1/the base station 110) using a beam direction associated with the beam indication. For example, the UE 120 may receive one or more downlink communications transmitted from the first TRP 705-1 (e.g., the base station 110) using a beam direction associated with the beam indication, and/or the UE 120 may transmit one or more uplink communications to the first TRP 705-1 (e.g., the base station 110) using a beam direction associated with the beam indication.

In a case in which the UE 120 is in the multiple-TRP mode, and the UE 120 receives a non-unified downlink beam indication (e.g., a non-unified TCI state), the UE 120 may receive downlink (e.g., PDSCH) communications from the first TRP 705-1 and the second TRP 705-2 using a first beam direction (e.g., a first TCI state) and a second beam direction (e.g., a second TCI state associated with the non-unified downlink beam indication). In some aspects, the UE 120 may receive multiple non-unified downlink beam indications (e.g., in multiple DCI in PDCCH communications from the first TRP 705-1 and the second TRP 705-2). In this case, the UE 120 may receive PDSCH communications from the first TRP 705-1 and the second TRP 705-2 using beam directions associated with the non-unified downlink beam indications. In a case in which the UE 120 is in the multiple-TRP mode and the UE 120 receives a non-unified uplink beam indication (e.g., a spatial relation indication), the UE 120 may transmit an uplink communication to the first TRP 705-1 or to the second TRP 705-2 using a beam direction associated with the non-unified uplink beam indication.

In some aspects, in a case in which the UE 120 is in the multiple-TRP mode and the UE 120 receives a unified TCI state indication, the UE 120 may communicate with the first TRP 705-1 and/or the second TRP 705-2 based at least in part on one or more of the beam indication rules that control how the unified TCI state indications are applied by the UE 120 in the multiple-TRP mode. As describe above, the unified TCI state indications may be applied to multiple channels. In some aspects, the UE 120 may receive a unified TCI indication in the single DCI multiple-TRP mode, and the unified TCI indication may be a separate downlink TCI state indication or a joint downlink and uplink TCI state indication to be applied to PDCCH and PDSCH. In this case, the unified TCI state indication may be associated with first and second TCI states, and the UE 120 may receive a PDSCH communication from the first TRP 705-1 on a first beam associated with the first TCI state and from the second TRP 705-2 on a second beam associated with the second TCI state. However, the UE 120 may apply a rule to select one of the first beam or the second beam to use to receive a PDCCH communication including DCI from the first TRP 705-1 or the second TRP 705-2. In some aspects, the UE 120 may use the beam with a lowest CORESET pool ID index among the first beam associated with the first TCI state and the second beam associated with the second TCI state to receive the DCI from the first TRP 705-1 or the second TRP 705-2.

In some aspects, the UE 120 may receive a unified TCI state indication in the multiple DCI multiple-TRP mode, and the unified TCI state indication may be a joint downlink and uplink TCI state indication. In this case, the unified TCI state indication may be associated with a first TCI state (e.g., a first beam direction) and second TCI state (e.g., a second beam direction), which may be used by the UE 120 for receiving downlink (e.g., PDSCH) communications from the first TRP 705-1 and the second TRP 705-2. However, the UE 120 may apply a rule to determine which beam (e.g., a first beam associated with the first TCI state or a second beam associated with the second TCI state) to use to transmit a PUCCH communication. In some aspects, the UE 120 transmit a PUCCH communication to the first TRP 705-1 or the second TRP 705-2 using the beam with the lowest CORESET pool ID index among the first beam associated with the first TCI state and the second beam associated with the second TCI state. In this case, the UE 120 may also apply a rule to determine which beam or beams to use for PUCCH repetitions (e.g., repetitions of a same PUCCH communication). In some aspects, the UE 120 may transmit the repetitions of the PUCCH communication on the first beam associated with the first TCI state and on the second beam associated with the second TCI state in an order based at least in part on the respective CORESET pool ID indexes associated with the first beam and the second beam. For example, the UE 120 may alternate between using the first beam and the second beam for transmitting repetitions of the PUCCH communication, starting with the beam with the lowest CORESET pool ID index among the first beam and the second beam.

As described above, the UE 120 may identify, based at least in part on configuration information received from a base station 110, whether the UE 120 is in a single-TRP mode or a multiple-TRP mode. The UE 120 may receive a beam indication that is one of a non-unified beam indication or a unified TCI state indication, and the type of the beam indication may be based at least in part on one or more beam indication rules for the single-TRP mode and the multiple-TRP mode. The UE 120 may then communicate with one or more TRPs 705 using one or more beam directions associated with the beam indication. In some aspects, the beam indication rules may determine whether a unified TCI state indication may be used in the multiple-TRP mode, and if so, how the UE 120 may determine which beams to use (e.g., in cases of single DCI multiple-TRP, joint downlink and uplink beam indication, and/or PDCCH or PUCCH repetitions). As a result, reliability may be increased, and latency decreased, for multiple-TRP communications for the UE 120.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with beam indications for single-TRP and multiple-TRP communications.

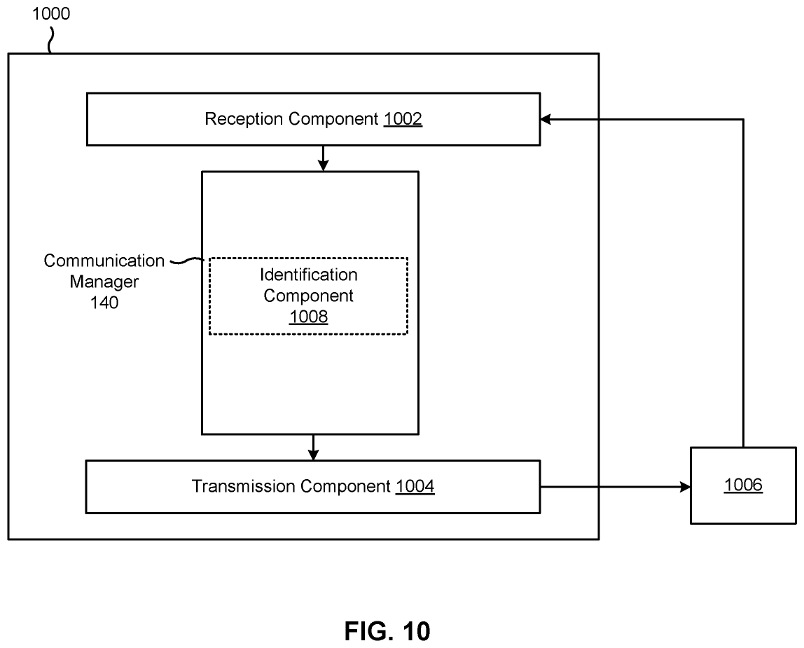

As shown in FIG. 8, in some aspects, process 800 may include identifying, based at least in part on configuration information received from a base station, whether the UE is in a single-TRP mode or a multiple-TRP mode (block 810). For example, the UE (e.g., using communication manager 140 and/or identification component 1008, depicted in FIG. 10) may identify, based at least in part on configuration information received from a base station, whether the UE is in a single-TRP mode or a multiple-TRP mode, as described above.

As further shown in FIG. 8, in some aspects, process 800 may include receiving a beam indication that is one of a non-unified beam indication or a unified TCI state indication, wherein a type of the beam indication is based at least in part on one or more beam indication rules for the single-TRP mode and the multiple-TRP mode (block 820). For example, the UE (e.g., using communication manager 140 and/or reception component 1002, depicted in FIG. 10) may receive a beam indication that is one of a non-unified beam indication or a unified TCI state indication, wherein a type of the beam indication is based at least in part on one or more beam indication rules for the single-TRP mode and the multiple-TRP mode, as described above.

As further shown in FIG. 8, in some aspects, process 800 may include communicating with one or more TRPs using one or more beam directions associated with the beam indication (block 830). For example, the UE (e.g., using communication manager 140, reception component 1002, and/or transmission component 1004, depicted in FIG. 10) may communicate with one or more TRPs using one or more beam directions associated with the beam indication, as described above.

Process 800 may include additional aspects, such as any single aspect or any combination of aspects described below and/or in connection with one or more other processes described elsewhere herein.

In a first aspect, receiving the beam indication includes receiving, based on the one or more beam indication rules, the non-unified beam indication in the multiple-TRP mode, or receiving, based on the one or more beam indication rules, the unified TCI state indication or the non-unified beam indication in the single-TRP mode.

In a second aspect, alone or in combination with the first aspect, process 800 includes receiving, from the base station, a beam indication configuration, and, in the single-TRP mode, the unified TCI state indication or the non-unified beam indication is based at least in part on a beam indication configuration.

In a third aspect, alone or in combination with one or more of the first and second aspects, process 800 includes transmitting, to the base station, a UE capability report including an indication of a UE capability associated with the unified TCI state indication, and, in the single-TRP mode, the unified TCI state indication or the non-unified beam indication is based at least in part on the UE capability.

In a fourth aspect, alone or in combination with one or more of the first through third aspects, process 800 includes transmitting, to the base station, a UE capability report including an indication of a UE capability associated with the unified TCI state indication for the multiple-TRP mode, and receiving the beam indication includes receiving the unified TCI state indication or the non-unified beam indication in the multiple-TRP mode based at least in part on the UE capability.

In a fifth aspect, alone or in combination with one or more of the first through fourth aspects, receiving the beam indication includes receiving the unified TCI state indication in the multiple-TRP mode.

In a sixth aspect, alone or in combination with one or more of the first through fifth aspects, the multiple-TRP mode is a single DCI multiple-TRP mode, the unified TCI state indication is at least one of a separate downlink TCI state indication or a joint downlink and uplink TCI state indication, the unified TCI state indication is associated with a first TCI state and a second TCI state, and communicating with one or more TRPs includes receiving DCI from a first TRP or a second TRP using a beam with a lowest control resource set pool identifier index among a first beam associated with the first TCI state and a second beam associated with a second TCI state.

In a seventh aspect, alone or in combination with one or more of the first through sixth aspects, communicating with one or more TRPs further includes receiving a physical downlink shared channel communication from the first TRP on the first beam associated with the first TCI state and from the second TRP on the second beam associated with the second TCI state.

In an eighth aspect, alone or in combination with one or more of the first through seventh aspects, the multiple-TRP mode is a multiple DCI multiple-TRP mode, the unified TCI state indication is a joint downlink and uplink TCI state indication, the unified TCI state indication is associated with a first TCI state and a second TCI state, and communicating with one or more TRPs includes transmitting a physical uplink control channel communication to a first TRP or a second TRP using a beam with a lowest control resource set pool identifier index among a first beam associated with the first TCI state and a second beam associated with a second TCI state.

In a ninth aspect, alone or in combination with one or more of the first through eighth aspects, the multiple-TRP mode is a multiple DCI multiple-TRP mode, the unified TCI state indication is a joint downlink and uplink TCI state indication, the unified TCI state indication is associated with a first TCI state and a second TCI state, and communicating with one or more TRPs includes transmitting repetitions of a physical uplink control channel communication on a first beam associated with the first TCI state and on a second beam associated with a second TCI state in an order based at least in part on respective control resource set pool identifier indexes associated with the first beam and the second beam.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with beam indications for single-TRP and multiple-TRP communications.

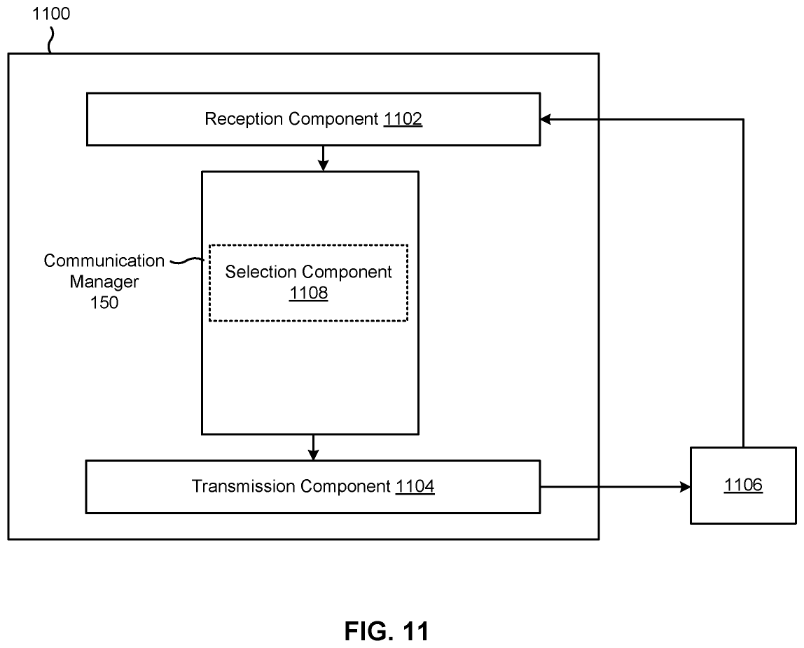

As shown in FIG. 9, in some aspects, process 900 may include transmitting, to a UE, configuration information that identifies whether the UE is in a single-TRP mode or a multiple-TRP mode (block 910). For example, the base station (e.g., using communication manager 150 and/or transmission component 1104, depicted in FIG. 11) may transmit, to a UE, configuration information that identifies whether the UE is in a single-TRP mode or a multiple-TRP mode, as described above.

As further shown in FIG. 9, in some aspects, process 900 may include transmitting, to the UE, a beam indication that is one of a non-unified beam indication or a unified TCI state indication, wherein a type of the beam indication is based at least in part on one or more beam indication rules for the single-TRP mode and the multiple-TRP mode (block 920). For example, the base station (e.g., using communication manager 150 and/or transmission component 1104, depicted in FIG. 11) may transmit, to the UE, a beam indication that is one of a non-unified beam indication or a unified TCI state indication, wherein a type of the beam indication is based at least in part on one or more beam indication rules for the single-TRP mode and the multiple-TRP mode, as described above.

As further shown in FIG. 9, in some aspects, process 900 may include communicating with the UE using one or more beam directions associated with the beam indication (block 930). For example, the base station (e.g., using communication manager 150, reception component 1102, and/or transmission component 1104, depicted in FIG. 11) may communicate with the UE using one or more beam directions associated with the beam indication, as described above.

Process 900 may include additional aspects, such as any single aspect or any combination of aspects described below and/or in connection with one or more other processes described elsewhere herein.

In a first aspect, transmitting the beam indication comprises transmitting, based on the one or more beam indication rules, the non-unified beam indication in the multiple-TRP mode, or transmitting, based on the one or more beam indication rules, the unified TCI state indication or the non-unified beam indication in the single-TRP mode.

In a second aspect, alone or in combination with the first aspect, process 900 includes transmitting, to the UE, a beam indication configuration, and, in the single-TRP mode, the unified TCI state indication or the non-unified beam indication is based at least in part on a beam indication configuration.

In a third aspect, alone or in combination with one or more of the first and second aspects, process 900 includes receiving, from the UE, a UE capability report including an indication of a UE capability associated with the unified TCI state indication, and, in the single-TRP mode, the unified TCI state indication or the non-unified beam indication is based at least in part on the UE capability.

In a fourth aspect, alone or in combination with one or more of the first through third aspects, process 900 includes receiving, from the UE, a UE capability report including an indication of a UE capability associated with the unified TCI state indication for the multiple-TRP mode, and transmitting the beam indication includes transmitting the unified TCI state indication or the non-unified beam indication in the multiple-TRP mode based at least in part on the UE capability.

In a fifth aspect, alone or in combination with one or more of the first through fourth aspects, transmitting the beam indication includes transmitting the unified TCI state indication in the multiple-TRP mode.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include an identification component 1008, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The identification component 1008 may identify, based at least in part on configuration information received from a base station, whether the UE is in a single-TRP mode or a multiple-TRP mode. The reception component 1002 may receive a beam indication that is one of a non-unified beam indication or a unified TCI state indication, wherein a type of the beam indication is based at least in part on one or more beam indication rules for the single-TRP mode and the multiple-TRP mode. The reception component 1102 and/or the transmission component 1104 may communicate with one or more TRPs using one or more beam directions associated with the beam indication.

The reception component 1002 may receive, from the base station, a beam indication configuration, wherein, in the single-TRP mode, the unified TCI state indication or the non-unified beam indication is based at least in part on a beam indication configuration.

The transmission component 1004 may transmit, to the base station, a UE capability report including an indication of a UE capability associated with the unified TCI state indication, wherein, in the single-TRP mode, the unified TCI state indication or the non-unified beam indication is based at least in part on the UE capability.

The transmission component 1004 may transmit, to the base station, a UE capability report including an indication of a UE capability associated with the unified TCI state indication for the multiple-TRP mode, wherein receiving the beam indication comprises receiving the unified TCI state indication or the non-unified beam indication in the multiple-TRP mode based at least in part on the UE capability.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a selection component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1106. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1106 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The transmission component 1104 may transmit, to a UE, configuration information that identifies whether the UE is in a single-TRP mode or a multiple-TRP mode. The transmission component 1104 may transmit, to the UE, a beam indication that is one of a non-unified beam indication or a unified TCI state indication, wherein a type of the beam indication is based at least in part on one or more beam indication rules for the single-TRP mode and the multiple-TRP mode. The reception component 1102 and/or the transmission component 1104 may communicate with the UE using one or more beam directions associated with the beam indication.

The selection component 1108 may select the beam indication for the UE based at least in part on the one or more beam indication rules for the single-TRP mode and the multiple-TRP mode.

The transmission component 1104 may transmit, to the UE, a beam indication configuration, wherein, in the single-TRP mode, the unified TCI state indication or the non-unified beam indication is based at least in part on a beam indication configuration.

The reception component 1102 may receive, from the UE, a UE capability report including an indication of a UE capability associated with the unified TCI state indication, wherein, in the single-TRP mode, the unified TCI state indication or the non-unified beam indication is based at least in part on the UE capability.

The reception component 1102 may receive, from the UE, a UE capability report including an indication of a UE capability associated with the unified TCI state indication for the multiple-TRP mode, wherein transmitting the beam indication comprises transmitting the unified TCI state indication or the non-unified beam indication in the multiple-TRP mode based at least in part on the UE capability.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:
Aspect 1: A method of wireless communication performed by a user equipment (UE), comprising: identifying, based at least in part on configuration information received from a base station, whether the UE is in a single-transmit receive point (TRP) mode or a multiple-TRP mode; receiving a beam indication that is one of a non-unified beam indication or a unified transmission configuration indicator (TCI) state indication, wherein a type of the beam indication is based at least in part on one or more beam indication rules for the single-TRP mode and the multiple-TRP mode; and communicating with one or more TRPs using one or more beam directions associated with the beam indication.
Aspect 2: The method of Aspect 1, wherein receiving the beam indication comprises: receiving, based on the one or more beam indication rules, the non-unified beam indication in the multiple-TRP mode; or receiving, based on the one or more beam indication rules, the unified TCI state indication or the non-unified beam indication in the single-TRP mode.
Aspect 3: The method of Aspect 2, further comprising: receiving, from the base station, a beam indication configuration, wherein, in the single-TRP mode, the unified TCI state indication or the non-unified beam indication is based at least in part on a beam indication configuration.
Aspect 4: The method of any of Aspects 2-3, further comprising: transmitting, to the base station, a UE capability report including an indication of a UE capability associated with the unified TCI state indication, wherein, in the single-TRP mode, the unified TCI state indication or the non-unified beam indication is based at least in part on the UE capability.
Aspect 5: The method of Aspect 1, further comprising: transmitting, to the base station, a UE capability report including an indication of a UE capability associated with the unified TCI state indication for the multiple-TRP mode, wherein receiving the beam indication comprises receiving the unified TCI state indication or the non-unified beam indication in the multiple-TRP mode based at least in part on the UE capability.
Aspect 6: The method of any of Aspects 1 or 5, wherein receiving the beam indication comprises: receiving the unified TCI state indication in the multiple-TRP mode.
Aspect 7: The method of Aspect 6, wherein the multiple-TRP mode is a single downlink control information (DCI) multiple-TRP mode, wherein the unified TCI state indication is at least one of a separate downlink TCI state indication or a joint downlink and uplink TCI state indication, wherein the unified TCI state indication is associated with a first TCI state and a second TCI state, and wherein communicating with the one or more TRPs comprises: receiving DCI from a first TRP or a second TRP using a beam with a lowest control resource set pool identifier index among a first beam associated with the first TCI state and a second beam associated with a second TCI state.
Aspect 8: The method of Aspect 7, wherein communicating with the one or more TRPs further comprises: receiving a physical downlink shared channel communication from the first TRP on the first beam associated with the first TCI state and from the second TRP on the second beam associated with the second TCI state.
Aspect 9: The method of Aspect 6, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein communicating with the one or more TRPs comprises: transmitting a physical uplink control channel communication to a first TRP or a second TRP using a beam with a lowest control resource set pool identifier index among a first beam associated with the first TCI state and a second beam associated with a second TCI state.
Aspect 10: The method of any of Aspects 6 or 9, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein communicating with the one or more TRPs comprises: transmitting repetitions of a physical uplink control channel communication on a first beam associated with the first TCI state and on a second beam associated with a second TCI state in an order based at least in part on respective control resource set pool identifier indexes associated with the first beam and the second beam.
Aspect 11: A method of wireless communication performed by a base station, comprising: transmitting, to a UE, configuration information that identifies whether the UE is in a single-transmit receive point (TRP) mode or a multiple-TRP mode; transmitting, to the UE, a beam indication that is one of a non-unified beam indication or a unified transmission configuration indicator (TCI) state indication, wherein a type of the beam indication is based at least in part on one or more beam indication rules for the single-TRP mode and the multiple-TRP mode; and communicating with the UE using one or more beam directions associated with the beam indication.
Aspect 12: The method of Aspect 11, wherein transmitting the beam indication comprises: transmitting, based on the one or more beam indication rules, the non-unified beam indication in the multiple-TRP mode; or transmitting, based on the one or more beam indication rules, the unified TCI state indication or the non-unified beam indication in the single-TRP mode.
Aspect 13: The method of Aspect 12, further comprising: transmitting, to the UE, a beam indication configuration, wherein, in the single-TRP mode, the unified TCI state indication or the non-unified beam indication is based at least in part on a beam indication configuration.
Aspect 14: The method of any of Aspects 12-13, further comprising: receiving, from the UE, a UE capability report including an indication of a UE capability associated with the unified TCI state indication, wherein, in the single-TRP mode, the unified TCI state indication or the non-unified beam indication is based at least in part on the UE capability.
Aspect 15: The method of Aspect 11, further comprising: receiving, from the UE, a UE capability report including an indication of a UE capability associated with the unified TCI state indication for the multiple-TRP mode, wherein transmitting the beam indication comprises transmitting the unified TCI state indication or the non-unified beam indication in the multiple-TRP mode based at least in part on the UE capability.
Aspect 16: The method of any of Aspects 11 or 15, wherein transmitting the beam indication comprises: transmitting the unified TCI state indication in the multiple-TRP mode.
Aspect 17: An apparatus for wireless communication at a device, comprising a processor; memory coupled with the processor; and instructions stored in the memory and executable by the processor to cause the apparatus to perform the method of one or more of Aspects 1-10.
Aspect 18: An apparatus for wireless communication at a device, comprising a processor; memory coupled with the processor; and instructions stored in the memory and executable by the processor to cause the apparatus to perform the method of one or more of Aspects 11-16.
Aspect 19: A device for wireless communication, comprising a memory and one or more processors coupled to the memory, the one or more processors configured to perform the method of one or more of Aspects 1-10.
Aspect 20: A device for wireless communication, comprising a memory and one or more processors coupled to the memory, the one or more processors configured to perform the method of one or more of Aspects 11-16.
Aspect 21: An apparatus for wireless communication, comprising at least one means for performing the method of one or more of Aspects 1-10.
Aspect 22: An apparatus for wireless communication, comprising at least one means for performing the method of one or more of Aspects 11-16.
Aspect 23: A non-transitory computer-readable medium storing code for wireless communication, the code comprising instructions executable by a processor to perform the method of one or more of Aspects 1-10.
Aspect 24: A non-transitory computer-readable medium storing code for wireless communication, the code comprising instructions executable by a processor to perform the method of one or more of Aspects 11-16.
Aspect 25: A non-transitory computer-readable medium storing a set of instructions for wireless communication, the set of instructions comprising one or more instructions that, when executed by one or more processors of a device, cause the device to perform the method of one or more of Aspects 1-10.
Aspect 25: A non-transitory computer-readable medium storing a set of instructions for wireless communication, the set of instructions comprising one or more instructions that, when executed by one or more processors of a device, cause the device to perform the method of one or more of Aspects 11-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
identify, based at least in part on configuration information received from a base station, whether the UE is in a single-transmit receive point (TRP) mode or a multiple-TRP mode;
receive a beam indication that is one of a non-unified beam indication or a unified transmission configuration indicator (TCI) state indication, wherein a type of the beam indication is based at least in part on one or more beam indication rules for the single-TRP mode and the multiple-TRP mode; and
communicate with one or more TRPs using one or more beam directions associated with the beam indication.

2. The UE of claim 1, wherein the one or more processors, to receive the beam indication, are configured to:
receive, based on the one or more beam indication rules, the non-unified beam indication in the multiple-TRP mode; or
receive, based on the one or more beam indication rules, the unified TCI state indication or the non-unified beam indication in the single-TRP mode.

3. The UE of claim 2, wherein the one or more processors are further configured to:
receive, from the base station, a beam indication configuration, wherein, in the single-TRP mode, the unified TCI state indication or the non-unified beam indication is based at least in part on a beam indication configuration.

4. The UE of claim 2, wherein the one or more processors are further configured to:
transmit, to the base station, a UE capability report including an indication of a UE capability associated with the unified TCI state indication, wherein, in the single-TRP mode, the unified TCI state indication or the non-unified beam indication is based at least in part on the UE capability.

5. The UE of claim 1, wherein the one or more processors are further configured to:
transmit, to the base station, a UE capability report including an indication of a UE capability associated with the unified TCI state indication for the multiple-TRP mode, wherein receiving the beam indication comprises receiving the unified TCI state indication or the non-unified beam indication in the multiple-TRP mode based at least in part on the UE capability.

6. The UE of claim 1, wherein the one or more processors, to receive the beam indication, are configured to:
receive the unified TCI state indication in the multiple-TRP mode.

7. The UE of claim 6, wherein the multiple-TRP mode is a single downlink control information (DCI) multiple-TRP mode, wherein the unified TCI state indication is at least one of a separate downlink TCI state indication or a joint downlink and uplink TCI state indication, wherein the unified TCI state indication is associated with a first TCI state and a second TCI state, and wherein the one or more processors, to communicate with the one or more TRPs, are configured to:
receive DCI from a first TRP or a second TRP using a beam with a lowest control resource set pool identifier index among a first beam associated with the first TCI state and a second beam associated with a second TCI state.

8. The UE of claim 7, wherein the one or more processors, to communicate with the one or more TRPs, are further configured to:
receive a physical downlink shared channel communication from the first TRP on the first beam associated with the first TCI state and from the second TRP on the second beam associated with the second TCI state.

9. The UE of claim 6, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein the one or more processors, to communicate with the one or more TRPs, are configured to:
transmit a physical uplink control channel communication to a first TRP or a second TRP using a beam with a lowest control resource set pool identifier index among a first beam associated with the first TCI state and a second beam associated with a second TCI state.

10. The UE of claim 6, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein the one or more processors, to communicate with the one or more TRPs, are configured to:
transmit repetitions of a physical uplink control channel communication on a first beam associated with the first TCI state and on a second beam associated with a second TCI state in an order based at least in part on respective control resource set pool identifier indexes associated with the first beam and the second beam.

11. A base station for wireless communication, comprising:
a memory; and
one or more processors, coupled to the memory, configured to:
transmit, to a user equipment (UE), configuration information that identifies whether the UE is in a single-transmit receive point (TRP) mode or a multiple-TRP mode;
transmit, to the UE, a beam indication that is one of a non-unified beam indication or a unified transmission configuration indicator (TCI) state indication, wherein a type of the beam indication is based at least in part on one or more beam indication rules for the single-TRP mode and the multiple-TRP mode; and
communicate with the UE using one or more beam directions associated with the beam indication.

12. The base station of claim 11, wherein the one or more processors, to transmit the beam indication, are configured to:
transmit, based on the one or more beam indication rules, the non-unified beam indication in the multiple-TRP mode; or
transmit, based on the one or more beam indication rules, the unified TCI state indication or the non-unified beam indication in the single-TRP mode.

13. The base station of claim 12, wherein the one or more processors are further configured to:
transmit, to the UE, a beam indication configuration, wherein, in the single-TRP mode, the unified TCI state indication or the non-unified beam indication is based at least in part on a beam indication configuration.

14. The base station of claim 12, wherein the one or more processors are further configured to:
receive, from the UE, a UE capability report including an indication of a UE capability associated with the unified TCI state indication, wherein, in the single-TRP mode, the unified TCI state indication or the non-unified beam indication is based at least in part on the UE capability.

15. The base station of claim 11, wherein the one or more processors are further configured to:
receive, from the UE, a UE capability report including an indication of a UE capability associated with the unified TCI state indication for the multiple-TRP mode, wherein transmitting the beam indication comprises transmitting the unified TCI state indication or the non-unified beam indication in the multiple-TRP mode based at least in part on the UE capability.

16. The base station of claim 11, wherein the one or more processors, to transmit the beam indication, are configured to:
transmit the unified TCI state indication in the multiple-TRP mode.

17. A method of wireless communication performed by a user equipment (UE), comprising:
identifying, based at least in part on configuration information received from a base station, whether the UE is in a single-transmit receive point (TRP) mode or a multiple-TRP mode;
receiving a beam indication that is one of a non-unified beam indication or a unified transmission configuration indicator (TCI) state indication, wherein a type of the beam indication is based at least in part on one or more beam indication rules for the single-TRP mode and the multiple-TRP mode; and
communicating with one or more TRPs using one or more beam directions associated with the beam indication.

18. The method of claim 17, wherein receiving the beam indication comprises:
receiving, based on the one or more beam indication rules, the non-unified beam indication in the multiple-TRP mode; or
receiving, based on the one or more beam indication rules, the unified TCI state indication or the non-unified beam indication in the single-TRP mode.

19. The method of claim 18, further comprising:
receiving, from the base station, a beam indication configuration, wherein, in the single-TRP mode, the unified TCI state indication or the non-unified beam indication is based at least in part on a beam indication configuration.

20. The method of claim 18, further comprising:
transmitting, to the base station, a UE capability report including an indication of a UE capability associated with the unified TCI state indication, wherein, in the single-TRP mode, the unified TCI state indication or the non-unified beam indication is based at least in part on the UE capability.

21. The method of claim 17, further comprising:
transmitting, to the base station, a UE capability report including an indication of a UE capability associated with the unified TCI state indication for the multiple-TRP mode, wherein receiving the beam indication comprises receiving the unified TCI state indication or the non-unified beam indication in the multiple-TRP mode based at least in part on the UE capability.

22. The method of claim 17, wherein receiving the beam indication comprises:
receiving the unified TCI state indication in the multiple-TRP mode.

23. The method of claim 22, wherein the multiple-TRP mode is a single downlink control information (DCI) multiple-TRP mode, wherein the unified TCI state indication is at least one of a separate downlink TCI state indication or a joint downlink and uplink TCI state indication, wherein the unified TCI state indication is associated with a first TCI state and a second TCI state, and wherein communicating with one or more TRPs comprises:
receiving DCI from a first TRP or a second TRP using a beam with a lowest control resource set pool identifier index among a first beam associated with the first TCI state and a second beam associated with a second TCI state.

24. The method of claim 23, wherein communicating with one or more TRPs further comprises:
receiving a physical downlink shared channel communication from the first TRP on the first beam associated with the first TCI state and from the second TRP on the second beam associated with the second TCI state.

25. The method of claim 22, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein communicating with one or more TRPs comprises:
transmitting a physical uplink control channel communication to a first TRP or a second TRP using a beam with a lowest control resource set pool identifier index among a first beam associated with the first TCI state and a second beam associated with a second TCI state.

26. The method of claim 22, wherein the multiple-TRP mode is a multiple downlink control information (DCI) multiple-TRP mode, wherein the unified TCI state indication is a joint downlink and uplink TCI state indication, wherein the unified TCI state indication is associated with a first TCI state and a second TCI state, and wherein communicating with one or more TRPs comprises:
transmitting repetitions of a physical uplink control channel communication on a first beam associated with the first TCI state and on a second beam associated with a second TCI state in an order based at least in part on respective control resource set pool identifier indexes associated with the first beam and the second beam.

27. A method of wireless communication performed by a base station, comprising:
transmitting, to a user equipment (UE), configuration information that identifies whether the UE is in a single-transmit receive point (TRP) mode or a multiple-TRP mode;
transmitting, to the UE, a beam indication that is one of a non-unified beam indication or a unified transmission configuration indicator (TCI) state indication, wherein a type of the beam indication is based at least in part on one or more beam indication rules for the single-TRP mode and the multiple-TRP mode; and
communicating with the UE using one or more beam directions associated with the beam indication.

28. The method of claim 27, wherein transmitting the beam indication comprises:
transmitting, based on the one or more beam indication rules, the non-unified beam indication in the multiple-TRP mode; or
transmitting, based on the one or more beam indication rules, the unified TCI state indication or the non-unified beam indication in the single-TRP mode.

29. The method of claim 27, further comprising:
receiving, from the UE, a UE capability report including an indication of a UE capability associated with the unified TCI state indication for the multiple-TRP mode, wherein transmitting the beam indication comprises transmitting the unified TCI state indication or the non-unified beam indication in the multiple-TRP mode based at least in part on the UE capability.

30. The method of claim 27, wherein transmitting the beam indication comprises:
transmitting the unified TCI state indication in the multiple-TRP mode.
